(19) United States
(12) Patent Application Publication
(10) Pub. No.: US 2010/0272608 A1
(43) Pub. Date: Oct. 28, 2010

(54) TEMPERATURE SENSOR AND BIOSENSOR USING THE SAME

(75) Inventors: Roel Penterman, Eindhoven (NL); Steven Van Lierop, Eindhoven (NL); Albert Hendrik Jan Immink, Eindhoven (NL); Dirk Jan Broer, Geldrop (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/743,827

(22) PCT Filed: Nov. 17, 2008
(86) PCT No.: PCT/IB08/54798

§ 371 Date: May 20, 2010

(30) Foreign Application Priority Data
Nov. 21, 2007 (EP) 07121172.6

(51) Int. Cl. G01N 30/96; G01K 11/12; G01N 25/00

(52) U.S. Cl. 422/69; 374/161; 73/61.76; 374/E11.018

(57) ABSTRACT

Embodiments of the invention relates to a temperature sensor and an analytical device comprising the same. The temperature sensor comprises a carrier (11) with a detection surface (12) on which temperature indicating agents (14) are present and, optionally, at which target components can collect and optionally bind to specific capture elements. An incident light beam (L1) is transmitted into the carrier and evanescent wave excitation is induced at the detection surface (12). The amount of light in the reflected light beam (L2) or an optical, e.g. luminescence response is then detected by a light detector (31). In one example, evanescent light is affected (absorbed, scattered) by temperature indicating agents and optionally target components and/or label particles at the binding surface (12) and will therefore be missing in a frustrated total internal reflected light beam (L2). This can be used to determine the temperature of the detection area and optionally the amount of target components at the binding surface (12) from the amount of light in the reflected light beam (L2, L2a, L2b). A magnetic field generator (41) is optionally used to generate a magnetic field (B) at the binding surface (12) by which magnetic label particles (1) can be manipulated, for example attracted or repelled.

### FIELD OF THE INVENTION

The present invention relates to a temperature sensor and to analytical devices using the same. In particular, the present invention permits a fast and precise measure of the temperature and/or the distribution thereof at the level of a temperature detection surface. The present invention also relates to a biosensor, such as e.g. an FTIR biosensor device comprising an optical detection area with integrated temperature monitoring and/or control means.

### BACKGROUND OF THE INVENTION

Precise temperature determination at the level of a surface of a device where an action occurs during an application is an important concept in a wide range of technologies. This is for instance particularly true in the field of biosensors where sensing at or near a sensing surface may be very dependent on the temperature. The presence and concentration of specific target biological compounds, such as but not limited to, DNA, RNA or proteins, in a sample fluid containing one or more other molecules can be determined by using the complex binding of these target biological compounds with probes on a sensing surface. As this binding is temperature dependent, the obtained detection of presence and/or concentration of specific target molecules also is temperature dependent.

Binding between capture probe (e.g. antibody) and the target biological compound (e.g. antigen, metabolite) is a thermodynamic process which occurs via formation of multiple non-covalent bonds. As a consequence the binding efficiency, i.e. the number of binding events, depends on the temperature. Therefore, to perform a quantitative measurement the temperature during the assay should be well controlled or at least be measured to perform a correction of the results afterwards. Moreover, the binding kinetics (speed of binding) is temperature dependent, i.e. the temperature will influence the total measurement time. Further, at high temperatures proteins can be become denaturated preventing the measurement to be carried out properly.

There is a need in the art for a precise and reliable method and device to measure the temperature, and its distribution, directly at the level of a carrier surface. There is also a need in the art for a method of making such temperature sensors and analytical devices comprising the same, wherein the method is easy to perform and does not significantly increase the costs of the device.

### SUMMARY OF THE INVENTION

An object of the present invention is to provide good temperature detection devices and analytical devices comprising the same, and to methods for monitoring and/or controlling the temperature of a detection area during processing. An advantage of embodiments of the present invention is that the temperature can be monitored and/or controlled at the level of a surface. Embodiments of the present invention also relate to a method of analysis of a sample fluid suspected of containing one or more analyte molecules such as target biological compounds.

The above objective is accomplished by a method and device according to the present invention.

The present invention relates to a temperature sensor for obtaining temperature-related information, the temperature sensor comprising a carrier with a temperature detection surface, the temperature detection surface adapted for receiving one or more temperature indicating agents thereon, wherein the one or more temperature indicating agents are operating by changing an optical property at a predetermined temperature and the temperature sensor is adapted for inducing an optical response from the one or more temperature indicating agents using evanescent wave excitation. The temperature detection surface may comprise one or more temperature indicating agents. It is an advantage of embodiments according to the present invention that the temperature sensing may be combined with a highly sensitive detection technique for detecting particles. It is an advantage of embodiments according to the present invention that the temperature sensor can be integrated in biosensing systems in an easy and substantially cost efficient way. It is an advantage of embodiments according to the present invention that the temperature system provides temperature information regarding the temperature at a surface. It is an advantage of embodiments according to the present invention that the temperature sensor may be dedicated for sensing within a particular temperature range or for sensing a particular temperature transition.

The temperature sensor may be adapted for obtaining an optical response from the one or more temperature indicating agents using frustrated total internal reflection.

The carrier may be adapted for receiving an incident electromagnetic radiation beam from outside the carrier such that evanescent wave excitation is experienced at the temperature detection surface. The temperature sensor may comprise an optical structure for receiving the electromagnetic radiation beam under an angle appropriate for having evanescent wave excitation at the temperature detection surface and/or an optical structure for appropriately coupling out a frustrated total internal reflected electromagnetic radiation beam. The optical structure(s) may comprise a surface which is adapted to be perpendicular to the incident electromagnetic radiation beam at the location where the incident electromagnetic radiation is coupled in or the reflected electromagnetic radiation beam at the location where the electromagnetic radiation is coupled out. It is an advantage of embodiments according to the present invention that the direction of the incident electromagnetic radiation beam and/or the reflected electromagnetic radiation beam will nor or only minimally changed during the transition into to the surrounding medium into the carrier or vice versa. Moreover, it is an advantage of embodiments according to the present invention that unwanted reflection during coupling in and coupling out of the beam will be minimised. The optical structure(s) may be integrated in the carrier. It is an advantage of embodiments according to the present invention that the number of separate components to be provided may be limited. Alternatively, the optical structures may be provided in an optical element separate from the carrier, which may allow to have a separation between a cartridge comprising the carrier and being disposable and the more expensive optical components which advantageously is re-usable.

The optical structure(s) may comprise one or more optical elements adapted to focus an incident electromagnetic radiation beam L1 on the temperature detection surface. It is an advantage of embodiments according to the present invention that light loss may be avoided.

The one or more temperature indicating agents may be present as one or more layers and/or spots. At least one of the one or more temperature indicating agents may be a temperature responsive polymer, co-polymer or hydrogel. It is an advantage of embodiments according to the present invention that these are easy to synthesise and to apply onto the surface. They can be obtained for various critical temperatures.

The temperature sensor may comprise a radiation source for emitting incident electromagnetic radiation into the carrier such that it experiences evanescent wave excitation and/or frustrated total internal reflection at the temperature detection surface. It is an advantage of embodiments according to the present invention that no external light source is required that less alignment is required.

The temperature sensor may comprise a detection means for detecting the electromagnetic radiation reflected from the temperature detection surface. The temperature sensor may comprise a detection means for detecting an optical response of the temperature indicating agents. It is an advantage of embodiments according to the present invention that no external detection means are required.

The present invention also relates to a biosensing device for sensing the presence and/or concentration of one or more analytes in a sample fluid, the biosensing device comprising a temperature sensor as described above for obtaining temperature-related information, and an analyte detection means for detecting the one or more analytes.

The temperature sensor and the analyte detection means may be adapted to use the same incident electromagnetic radiation beam. It is an advantage of some embodiments according to the present invention that the same radiation source may be used. It is an advantage of some embodiments according to the present invention that the same detection means may be used for detecting temperature-related information and for analyte detection.

The bio sensing device furthermore may comprise a processing means for determining a presence and or concentration of the one or more analytes taking into account the one or more analytes.

The device furthermore may comprise a heat control means for controlling a temperature of the analyte detection means as function of the temperature-related information. The heat control means may comprise a heater and/or a cooler.

The present invention furthermore relates to a temperature indicating agent, the temperature indicating agent comprising temperature sensitive structures having at least one temperature dependent dimension, such that temperature related information can be derived from the distance between the temperature indicating agent and the surface when the temperature indicating agent is received on the surface. It is an advantage of embodiments according to the present invention that a versatile, fast and easy alternative for printing of a temperature indicating agent on the temperature detection surface can be obtained. The temperature indicating agent may be adapted to specifically bind to a surface. The surface may be a particular surface of a carrier or it may be a surface of a target molecule.

The present invention relates to a method for gaining temperature-related information comprising the steps of obtaining a temperature sensor having a temperature detection surface comprising one or more temperature indicating agents, each operating by changing an optical property at a predetermined temperature, and obtaining temperature-related information from the one or more temperature indicating agent, by directing an incident electromagnetic radiation into the temperature sensor such that it experiences evanescent wave excitation or frustrated total internal reflection at the temperature detection surface, and determining an optical response of the temperature indicating agents.

The present invention furthermore relates to a method for analyzing one or more analytes in a sample fluid, the method comprising the steps of
obtaining a temperature sensor comprising a carrier having a temperature detection surface comprising one or more temperature indicating agents,
each operating by changing an optical property at a predetermined temperature, and a particle detection surface,
contacting the detection surfaces of the carrier with the sample fluid, obtaining temperature-related information from the one or more temperature indicating agent, by directing an incident electromagnetic radiation into the temperature sensor such that evanescent wave excitation is induced or frustrated total internal reflection is experienced at the temperature detection surface, and determining an optical response of the temperature indicating agents, and
detecting the one or more analytes in the sample fluid.

The detecting of one or more analytes in the sample fluid may be performed by directing an incident electromagnetic radiation into the temperature sensor such that it experience total internal reflection or frustrated total internal reflection at the particle detection surface and detecting the intensity of electromagnetic radiation reflected from the particle detection surface. It is an advantage of embodiments according to the present invention that obtaining temperature related information and detecting one or more analytes may be performed simultaneously, e.g. using the same illumination beam.

The method furthermore may comprise determining the presence and/or the concentration of the one or more analytes in the sample fluid by combining a detection result for the detecting of the one or more analytes in the sample fluid with the obtained temperature-related information. It is an advantage of embodiments according to the present invention that a more accurate determination of the presence and/or concentration of analytes of interest in the sample fluid can be determined.

Prior to detecting one or more analytes in the sample fluid, the method may further comprise bringing the particle detection surface to a predetermined temperature taking into account the obtained temperature-related information. It is an advantage of embodiments according to the present invention that a more accurate determination of the presence and/or concentration of analytes of interest in the sample fluid can be determined.

It is an advantage of embodiments according to the present invention that the performance of the biochemical assay can be improved when the temperature during the measurement is known and can be adjusted. Alternatively, the measured temperature can be used to feed forward correct the result of the assay at a variable temperature.

Embodiments of the present invention may use the finding that the temperature of a detection area such as e.g. an optical detection area where evanescent wave excitation occurs, can be monitored and/or controlled in a precise and/or fast manner. This may be obtained using deposition of one or more temperature indicating agents at the surface of the detection area as one or more layers and/or spots or bringing such temperature indicating agents near the surface and using these for obtaining temperature information. The deposited agents may operate by changing their optical properties, dependent upon the temperature.

Devices comprising such a temperature detection surface have the advantage to permit monitoring of the temperature of the detection area itself.

Particular and preferred aspects of the invention are set out in the accompanying independent and dependent claims. Features from the dependent claims may be combined with features of the independent claims and with features of other dependent claims as appropriate and not merely as explicitly set out in the claims.

The teachings of the present invention permit the design of improved methods and apparatus for sensing particles of interest in a sample.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

The present invention, its embodiments and advantages will be described with reference to the following drawings.

FIG. 1 schematically shows the general setup of a temperature sensor according to an embodiment of the present invention.

FIG. 2 schematically shows a device for detecting one or more analytes in a sample fluid according to an embodiment of the present invention.

FIG. 3 schematically shows an enlarged portion of FIG. 2 schematically representing a temperature detection area for a temperature below the critical temperature (A) and a temperature above the critical temperature (B) according to an embodiment of the present invention.

FIG. 4 schematically shows a method for measuring a temperature according to an embodiment of the present invention.

FIG. 5 shows on the one hand the response of the light sensor as a function of time for a first example of a temperature sensor and on the other hand the appearance of a freestanding hydrogel disk of the first example below (bottom left) and above (bottom right) its LCST, according to an embodiment of the present invention.

FIG. 6 shows the response of the light sensor as a function of time for a second example of a temperature measurement according to an embodiment of the present invention.

FIGS. 7 to 11 schematically show different examples of devices for detecting one or more analytes in a sample fluid according to embodiments of the present invention.

FIG. 12 illustrates a coiled state (left hand side) of a temperature indicating agent above the LCST and an uncoiled state (right hand side) of a temperature indicating agent below the LCST and their corresponding luminescence response upon excitation with an evanescent wave, as can be used according to embodiments of the present invention.

FIG. 13 illustrates coiled and uncoiled states of a temperature indicating agent as shown in FIG. 12, whereby the temperature indicating agent is not bound to the detection surface.

### DETAILED DESCRIPTION OF EMBODIMENTS

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

As used herein, and unless stated otherwise, the term “analyte” designates a small molecule such as e.g. a drug of abuse or a biological molecular compound fixed as a goal or point of analysis. It includes biological molecular compounds such as, but not limited to, nucleic acids and related compounds (e.g. DNAs, RNAs, oligonucleotides or analogs thereof, PCR products, genomic DNA, bacterial artificial chromosomes, plasmids and the like), proteins and related compounds (e.g. polypeptides, peptides, monoclonal or polyclonal antibodies, soluble or bound receptors, transcription factors, and the like), antigens, ligands, haptens, carbohydrates and related compounds (e.g. polysaccharides, oligosaccharides and the like), cellular fragments such as membrane fragments, cellular organelles, intact cells, bacteria, viruses, protozoa, and the like.

As used herein, and unless stated otherwise, the term “probe” designates a biological agent being capable to bind specifically with a “target biological compound” when put in the presence of or reacted with the target biological compound, and used in order to detect the presence and/or concentration of the target biological compound. Probes include biological molecular compounds such as, but not limited to, nucleic acids and related compounds (e.g. DNAs, RNAs, oligonucleotides or analogs thereof, PCR products, genomic DNA, bacterial artificial chromosomes, plasmids and the like), proteins and related compounds (e.g. polypeptides, monoclonal antibodies, receptors, transcription factors, and the like), antigens, ligands, haptens, carbohydrates and related compounds (e.g. polysaccharides, oligosaccharides and the like), cellular organelles, intact cells, and the like. Probes may also include specific materials such as certain biopolymers to which target compounds bind.

As used herein, and unless stated otherwise, the term “hydrogel” designates a polymer network capable of swelling in water and other aqueous media, and retaining large volumes of water in the swollen state. In the swollen state, hydrogels consist of a three-dimensional network of polymer chains that are solvated by water molecules while the chains are chemically or physically linked to each other, thus preventing the polymer network from dissolving in the aqueous environment.

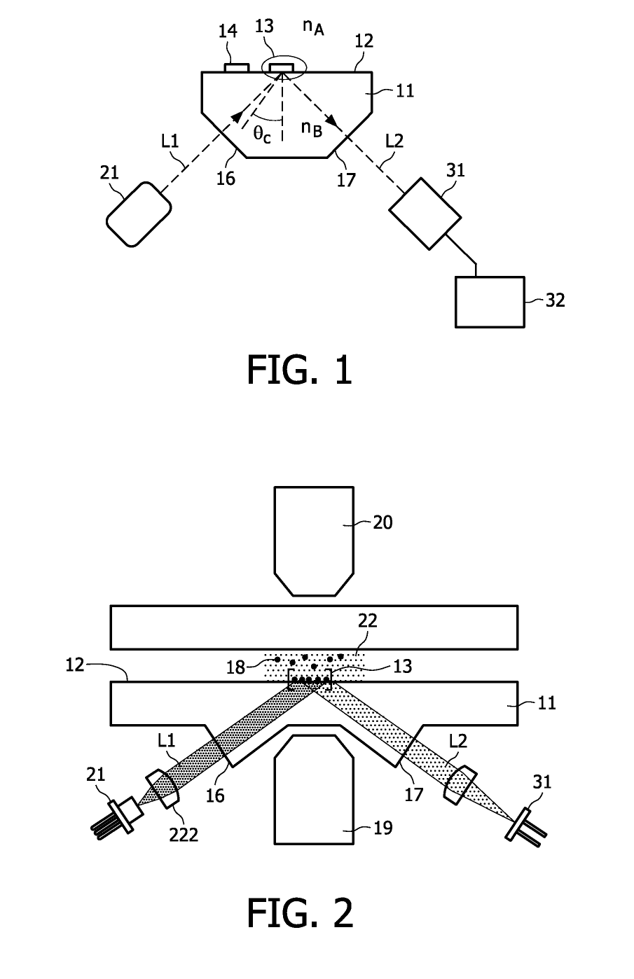

In a first aspect, the present invention relates to a temperature sensor, i.e. a system able to provide temperature-related information. In embodiments of the present invention, the temperature sensor comprises a carrier with a temperature detection surface. The temperature detection surface comprises one or more temperature indicating agents operating by changing an optical property at a predetermined temperature. The temperature sensor furthermore is adapted for providing an optical response from the one or more temperature indicating agents using evanescent wave excitation. Detection may be based on frustrated total internal reflection or luminescence detection. By way of example, the present invention not being limited thereto, standard and optional components of the temperature sensor according to an embodiment of the present aspect are described with reference to FIG. 1.

FIG. 1 shows a setup of a temperature sensor 10 according to an embodiment of the present invention. The carrier 11 has a temperature detection surface 12 which functions as temperature detection area 13. One main function of the carrier is to comprise the temperature detection surface, although the carrier 11 also may comprise a detection surface for detecting particles, as will be discussed further. The temperature detection surface 12 is a surface of the carrier from where the temperature sensor 10 will gain temperature-related information. The carrier 11 preferably has a high transparency for electromagnetic radiation of a given spectral range, particularly electromagnetic radiation emitted by a means for emitting incident electromagnetic radiation (e.g. a light source) that may be used for the present system and will be defined elsewhere in the description. The carrier may for example be produced from glass or some transparent plastic like polystyrene. While it is in principle possible that the carrier 11 has some dedicated structure with multiple components of different materials, it is advantageous that the carrier is homogenously fabricated from a single material, for example a transparent plastic. The carrier 11 can thus readily be produced for example by injection moulding.

The temperature sensor 10 of the present invention further comprises one or more temperature indicating agents 14 operating by changing an optical property at a predetermined temperature and being present on the temperature detection surface 12. For instance, in an embodiment of the present invention, the detection surface 12 may have, deposited at its surface as one or more layers and/or spots, at least one agent which indicates temperature through a change in an optical property. The change in an optical property indicating a change in temperature advantageously may result in an optical response, e.g. by frustrating the total internal reflection of an incident electromagnetic beam or a luminescence response. This is for instance the case when the temperature indicating agent operates by becoming opaque/turbid or by attracting scattering moieties towards the temperature indicating surface. In another embodiment, the change in an optical property indicating a change in temperature advantageously operates by affecting the critical angle of reflection of an incident electromagnetic beam. This is for instance the case when the temperature indicating agent operates by changing its refractive index. The temperature detection surface 12 or temperature detection areas of the carrier 11 may be corrugated or made rough. This is advantageous in some embodiments because it permits the incident electromagnetic radiation to hit the carrier-temperature indicating agent interface at a range of angles, therefore creating a pattern of electromagnetic radiation reflection which is dependent on the refractive index of the temperature indicating agent. The observation of this pattern change can be used as an indication that the temperature indicating agent changed its refractive index which in turn gives information on the temperature of the temperature indicating surface and/or area. Advantageously, this change in optical property operates at a temperature or within a temperature range comprised between about 0° C. and about 95° C., advantageously between 0° C. and 75° C., more advantageously between 0° C. and 40° C. Also, this change in optical property, e.g. a lower critical solution temperature transition, advantageously occurs and is detectable within not more than 5° C., preferably not more than about 3° C., more preferably not more than about 1° C. and most preferably not more than 0.5° C. The change in refractive index may be continuously, whereby the detection limit depends on the sensitivity of the detector used. The detector may be adapted for distinguishing changes in optical properties upon a temperature variation smaller than 5° C., advantageously to distinguish optical properties upon a temperature variation smaller than 0.1° C. This feature is advantageous because it permits to accurately assess the temperature of the temperature detection surface 12. Typically, the change of optical property is observed when a given temperature is reached and/or passed. The measurement of this property permits therefore to determine whether the temperature of the temperature detection surface 12 is above or under this temperature range.

The temperature indicating agents 14 may be any type of materials that exhibit a different optical property once a critical temperature T_{c} is crossed. One example of such a material may be a hydrogel. Temperature responsive (hydrophilic) polymers, co-polymers or hydrogels exhibiting a lower critical solution temperature (LCST) may be used as temperature indicating agents. These polymers, co-polymers or hydrogels switch from a transparent to a scattering state above the LCST. Non limitative examples of temperature responsive polymers includes polymers, co-polymers or hydrogels based on one or more N-substituted acrylamides (e.g. N-alkylacrylamides) such as poly(N-isopropyl acrylamide) (PNIPPAAM) (LCST=32° C.), poly(N,N′-diethyl-acrylamide) (LCST=25 to 35° C.), carboxylsopropylacrylamide, hydroxymethylpropylmethacrylamide and poly(-N-acryloyl-N′-alkylpiperazine) (LCST=37° C.). Below the critical temperature Tc (here LCST), such hydrogels are hydrophilic and swell homogeneously in presence of an aqueous fluid. They are therefore optically transparent. As a result, the intensity of an incident electromagnetic radiation beam is reflected without loss of intensity. When the temperature increases above Tc, the temperature indicative agent 14 becomes hydrophobic, phase separates from the fluid, and starts to scatter the evanescent wave. This results in a decreased reflection of the incident electromagnetic radiation beam. Determining whether the temperature at the temperature indicating surface 12 is below or above Tc can be operated by measuring the intensity of the electromagnetic radiation beam reflected from the position of the hydrogel element. By tuning the material properties this transition temperature can be altered. By printing multiple spots with different transition temperatures, a wide range of temperatures can be measured. Alternatively or in addition thereto, the temperature indicating agent also may have a particular luminescent behaviour above or below a critical temperature, thus giving an indication of the temperature at the surface.

The temperature indicating agents 14 can be made by printing droplets of the agent, e.g. reactive hydrogel monomer mixtures, on top of the carrier 11 (at the temperature indicating area, i.e. within the optical read-out window). Subsequently, these droplets may be polymerized, e.g. by applying UV radiation. Temperature responsive hydrogels may be made for instance by mixing one or more N-substituted acrylamide monomers with an effective amount of one or more crosslinkers. suitable examples of crosslinkers include, but are not limited to N,N-methyl-bisacrylamide, poly(ethyleneglycol) diacrylate, tetraethylene glycol di(meth)acrylate, triethylene glycol di(meth)acrylate, diethylene glycol di(meth)acrylate, tripropyleneglycol di(meth)acrylates, pentaerythritol tri(meth)acrylate polyethyleneglycoldi(meth)acrylate, ethoxylated bisphenol-A-di(meth)acrylate and hexanedioldi(meth)acrylate. The molar ratio monomer:crosslinker may suitably be in the range between 1:25 and 1:1000. Furthermore, an initiator (either a photo-initiator or a thermal initiator) may be added in order to initiate polymerization (e.g. in a 1 to 10 wt % ratio with respect to the monomer). The one or more monomers may be mixed with an aqueous solvent (typically between 50 and 95% by weight H₂O or a H₂O/methanol mixture) and the mixture is then deposited onto the carrier for instance by means of ink-jet printing and is subsequently polymerised.

When H₂O or a H₂O/methanol is used as a solvent, advantageously the polymerization is conducted at temperatures below the LCST of the hydrogel in order to prevent phase separation during the polymerization. Alternatively, instead of H₂O or a H₂O/methanol a solvent can be used for which the total mixture does not show LCST behaviour e.g. organic solvent like toluene, (cyclo)hexane, anisole etc. After the polymerization, the solvent can be washed out.

An example of a temperature-responsive polymer is poly(N-isopropylacrylamide), which undergoes a sharp coil-globule transition in water at 32° C., changing from a hydrophilic state below this temperature to a hydrophobic state above it. The temperature at which the phase transition occurs (the Lower Critical Solution Temperature or LCST) is largely dependent on the hydrogen-bonding capabilities of the constituent monomer units. Accordingly, the LCST of a given polymer can be “tuned” as desired by variation in hydrophilic or hydrophobic co-monomer content. Examples of hydrophilic monomers comprise hydroxyethyl(meth)acrylate, (meth)acrylic acid, acrylamide, polyethyleneglycol(meth)acrylate or mixtures thereof whereas examples of hydrophobic monomers: comprising (iso)butyl(meth)acrylate, methylmethacrylate, isobornyl(meth)acrylate or mixtures thereof.

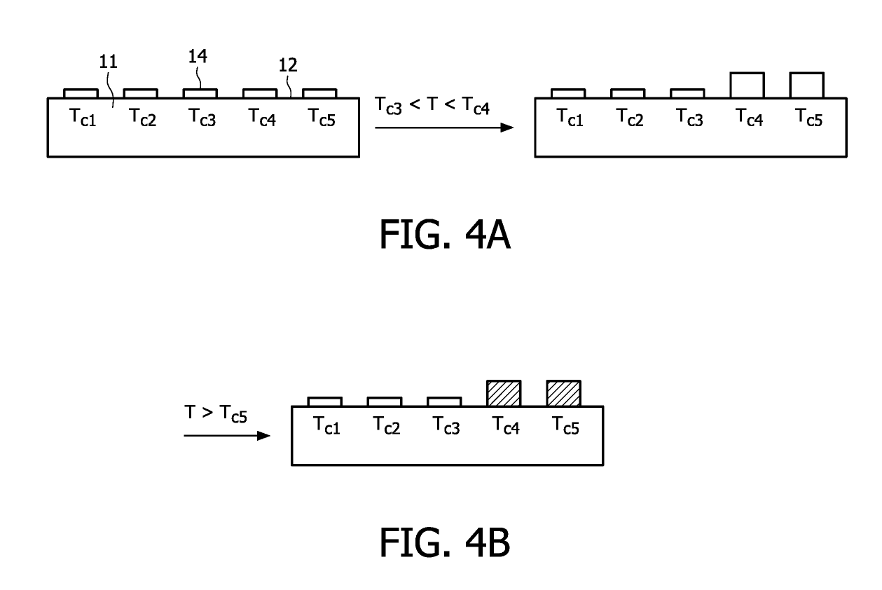

As an example, the LCST of poly-(NIPAAM-co-PEGA) hydrogels containing between 2 and 9% of PEGA (polyethyleneglycolacrylate, Mw-375) varies from around 32° C. to around 46° C. Such hydrogels can be easily synthesized by using e.g. 9.9% of a monomer mixture, 89% of water, 0.1% of diethyleneglycoldiacrylate as a cross-linker and 1% IRG 2959. When temperature responsive polymers are crosslinked, one can obtain temperature responsive hydrogels. For instance, a crosslinked network of PNIPAAm thus swells in aqueous environment if the temperature is below its transition state and the network will contract above this temperature. This response changes the optical properties of the gel (FIG. 3): Above the LCST water separates from the polymer chains and small water droplets are formed inside the gel. This random structure of dispersed water droplets in the polymer, with both phases having a different index of refraction, scatters the incident electromagnetic radiation. In embodiments where the temperature indicating agents 14 are hydrogel, it is useful to note that temperature responsive hydrogels only can scatter electromagnetic radiation if they contain a significant amount of water. During storage of the temperature sensor (e.g. as being a part of a microfluidic bio sensor cartridge) before the actual test is carried out, the hydrogel elements can be in their dry state i.e. they do not contain any aqueous fluid.

In a particular embodiment the temperature detecting agent is chemically bound to the temperature detection surface by an adhesion promoter. In case of a glass surface such a promoter may for example be silanes, like HDMS (hexadimethylsiloxane) or 3-(trimethoxysilyl)propyl methacrylate.

In another example, the temperature detecting agent operates by changing its refractive index and the interface between the temperature indicating agent and the carrier as been made rough or has been corrugated. In this embodiment, the temperature transition may be detected by measuring a change in reflection pattern

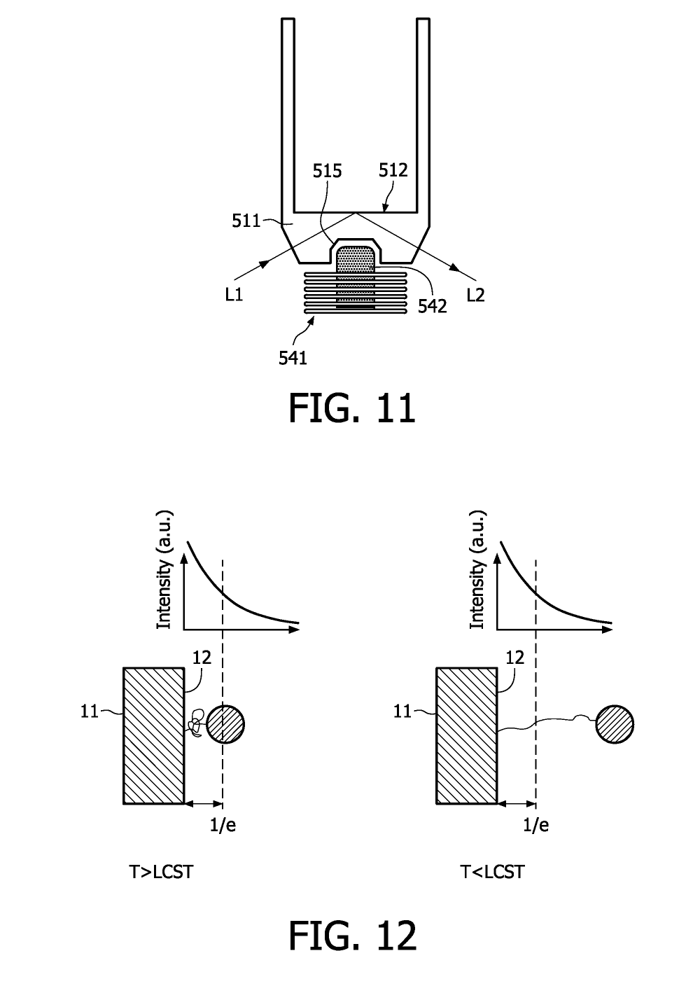

In yet another example temperature sensitive polymer brushes may be bound to the temperature detection surface. In a collapsed state (above the LCST of the polymer) the index of refraction (and scattering) is higher than in the elongated (uncoiled) state. To increase the signal contrast the end of the brushes can be bound to beads (for instance latex beads such as but not limited to fluorescent beads) or any other detectable entity. Alternatively or in addition thereto, magnetic beads that are dispensed in the liquid in a non-bound state can be pulled towards the surface using an magnetic force, e.g. external or internal, and depending on the conformation of the brushes, the beads will stay outside or will be pulled into the evanescent field. Above the LCST the brushes pull the beads into the evanescent wave resulting in scattering and a concomitant decrease of the intensity of the reflected beam. The intensity decay distance (1/e) of the evanescent wave is in the order of 100 nm. The translation range of the coiled and uncoiled state advantageously is in the order of this value or larger than this value. FIG. 12 illustrates both a coiled state (left hand side) of a temperature indicating agent above the LCST and an uncoiled state (right hand side) of a temperature indicating agent below the LCST and their corresponding luminescence response upon excitation with an evanescent wave.

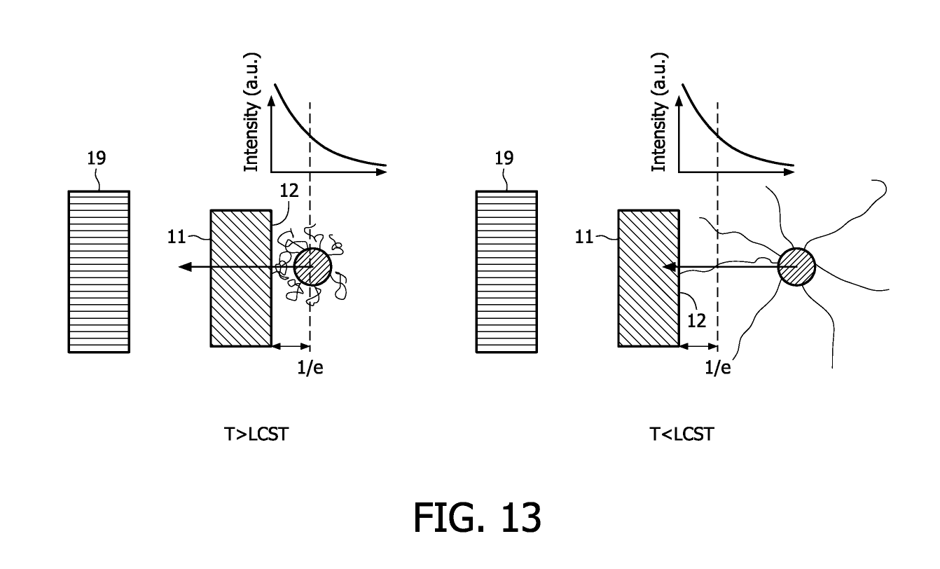

In another example the surface of the carrier may be adapted with receiving probes for receiving temperature indicating agents that can bind to the temperature detection surface. The temperature indicating agent comprises temperature sensitive structures having at least one temperature dependent dimension such that temperature related information can be derived from the distance between the temperature indicating agent and the surface when the temperature indicating agent is bound to the surface. An example of such temperature indicating agents are beads, such as e.g. magnetic beads, which are coated with temperature sensitive polymer brushes. Alternatively, such beads coated with temperature indicating agents like temperature sensitive polymer brushes may also be used with a carrier surface that is not adapted with receiving probes. During an assay, the beads are pulled towards the sensor surface by e.g. a magnet. The length of the polymer brushes is chosen such that in the collapsed state the beads are pulled into the evanescent wave, whereas the temperature is below the LSCT the beads remain outside. FIG. 13 illustrates both a coiled state (left hand side) of a temperature indicating agent above the LCST and an uncoiled state (right hand side) of a temperature indicating agent below the LCST and their corresponding luminescence response upon excitation with an evanescent wave for non-bound beads.

Whereas in the present aspect, the temperature sensor is described comprising the one or more agents, embodiments of this invention also relate to a temperature sensor with a carrier having a temperature detection surface adapted for binding with such temperature indicating agents, i.e. the temperature indicating agents not being part of the carrier. In one aspect, the present invention therefore furthermore relates to the temperature indicative agents that are capable of binding to a surface of a carrier themselves. In other embodiments, the present invention also relates to the particles coated with temperature indicating agents as described above, which can be positioned near the detection surface of the sensor. Such particles may be e.g. beads.

According to the present invention, the temperature sensor 10 is adapted for providing an optical response from the one or more temperature indicating agents 14 using evanescent wave excitation. It may for example be designed in such a way that an incident electromagnetic radiation beam directed from outside the carrier 11 can enter the carrier 11 and experience evanescent wave excitation at the temperature detection surface 12. Detection may of temperature related information may be performed by detecting the total internal frustrated reflection of the incident electromagnetic radiation beam or e.g. a luminescence response of the temperature indicating agents. In one embodiment, this adaptation comprises at least one optical structure being integrated in the carrier 11 for receiving an incident electromagnetic radiation beam from outside the carrier 11 so that it enters the carrier 11 and is experiencing frustrated total internal reflection at the temperature detection surface 12. In addition or alternatively, an optical structure may be provided whereby the reflected electromagnetic radiation beam leaves the carrier through an optical structure. These optical structure may have a surface of the carrier which is substantially perpendicular to the incident electromagnetic radiation beam and/or to the reflected electromagnetic radiation beam in the region where this beam enters or leaves the carrier, i.e. the angle of incidence lies in a range of about ±5° around 90°. In this case the direction of the incident electromagnetic radiation beam and/or the reflected electromagnetic radiation beam will not or only minimally change during the transition from a surrounding medium into the carrier or vice versa. The latter is advantageous to obtain a good coupling in and/or out the optical components. The reflection then will be minimized. Additionally or alternatively, the corresponding regions may also have an anti-reflection coating. To prevent reflection back into the electromagnetic radiation source (e.g. a laser), it may be advantageous to have the incident beam (at most) a few degrees off-perpendicular. The temperature sensor 10 of embodiments of the present invention thus is adapted for providing an optical response using evanescent wave excitation, in the present example using frustrated total internal reflection, thus providing temperature related information. In one example, as shown in FIG. 1, the carrier 11 may comprise a first optical structures 16 integrated in the carrier 11. It may be adapted to have an optical surface perpendicular to the incident electromagnetic radiation beam L1 at the location where the incident electromagnetic radiation L1 enters the carrier 11. The carrier 11 may further comprise a second optical structures 17 integrated to the carrier 11 or as a separate component. This second optical structure 17 may be adapted to have an optical surface perpendicular to the reflected electromagnetic radiation beam L2 at the location where the reflected electromagnetic radiation L2 enters the carrier 11. The incident electromagnetic radiation beam L1 arrives at the detection surface 12 at an angle larger than the critical angle θ_{c} for total internal reflection (TIR) and therefore undergoes total internal reflection or frustrated total internal reflection, resulting in a“reflected electromagnetic radiation beam” L2. The reflected electromagnetic radiation beam L2 leaves the carrier 11 through another surface (optical structure 17) and may be detected by an electromagnetic radiation detector 31. The electromagnetic radiation detector 31 can detect the amount of electromagnetic radiation of the reflected electromagnetic radiation beam L2 (e.g. expressed by the electromagnetic radiation intensity of this electromagnetic radiation beam in the whole spectrum or a certain part of the spectrum). The measurement results are evaluated and optionally monitored over an observation period by an evaluation and recording module 32 that is coupled to the detector 31. The temperature sensor uses the principle of frustrated total internal reflection. According to Snell's law of refraction, the angles θ_{A} and θ_{B} with respect to the normal of an interface between two media A and B satisfy the equation

n_{A} sin θ_{A}=n_{B} sin θ_{B}

with n_{A} and n_{B} being the refractive indices in medium A and B, respectively. A ray of electromagnetic radiation in a medium A with high refractive index (e.g. glass with n_{A}=1.5) will for example refract away from the normal under an angle θ_{B} at the interface with a medium B with lower refractive index such as air (n_{B}=1) or water (n_{B}≈1.3). A part of the incident electromagnetic radiation will be reflected at the interface, with the same angle as the angle θ_{A} of incidence. When the angle θ_{A} of incidence is gradually increased, the angle θ_{B} of refraction will increase until it reaches 90°. The corresponding angle of incidence is called the critical angle, θ_{c}, and is given by sin θ_{c}=n_{B}/n_{A}. At larger angles of incidence, all electromagnetic radiation will be reflected inside medium A (glass), hence the name “total internal reflection”. However, very close to the interface between medium A (glass) and medium B (air or water), an evanescent wave is formed in medium B, which decays exponentially away from the surface. The field amplitude as function of the distance z from the surface can be expressed as:

exp(−k\sqrt{n_{A}² sin²(θ_{A})−n_{B}²}·z)

with k=2π/λ, θ_{A} being the incident angle of the totally reflected beam, and n_{A} and n_{B} the refractive indices of the respective associated media. For a typical value of the wavelength λ, e.g. λ=650 nm, and n_{A}=1.53 and n_{B}=1.33, the field amplitude has declined to exp(−1)≈0.37 of its original value after a distance z of about 228 nm. When this evanescent wave interacts with another medium like the temperature indicative agents 14 in the setup of FIG. 1, part of the incident electromagnetic radiation will be coupled into the sample fluid (this is called “frustrated total internal reflection”), and the reflected intensity will be reduced (while the reflected intensity will be 100% for a clean interface and no interaction). Depending on the amount of disturbance, i.e. the optical state of the temperature indicative agent 14, the reflected intensity will drop accordingly. This intensity drop is related to the optical state of the temperature indicative agent 14, and therefore to the temperature of the temperature detection surface. The term “frustrated total internal reflection” thus refers to the case where some of the incident electromagnetic radiation is lost (absorbed, scattered etc.) during the reflection process. The electromagnetic radiation reflected from the detection surface shall both be a unique reference to the electromagnetic radiation (e.g. light) that is caught by the detector and imply that all electromagnetic radiation of this beam stems from the aforementioned total internal reflection or frustrated total internal reflection of the incident electromagnetic radiation beam. It is however not necessary that the electromagnetic radiation reflected from the detection surface comprises all the totally internally reflected electromagnetic radiation (though this will preferably be the case), as some of this electromagnetic radiation may for example be used for other purposes or simply be lost.

The carrier may particularly comprise at least one surface with a form similar or identical to a hemisphere or a truncated pyramid. As will be discussed in more detail with reference to the Figures, these forms may function like lenses and/or prisms and thus provide a favourable guidance of the incident and the reflected electromagnetic radiation beam.

The temperature sensor according to embodiments of the present invention may comprise detection means 31 for detecting a change in optical property. Such detection means 31 may be detection means for detecting the intensity of electromagnetic radiation reflected from the temperature detection surface 12. The detection means 31 may comprise any suitable sensor or plurality of sensors by which electromagnetic radiation of a given spectrum can be detected, for example a photodiode, a photo resistor, a photocell, or a photo multiplier tube, CCD among others. The detection means 31 may also be external to the temperature sensor and the temperature sensor may be sold or purchased without the detection means. The detection means 31 may be adapted for measuring a change in reflectively of a frustrated total internal reflection beam or alternatively may be adapted for detecting a luminescence response from the temperature indicative agents. Detection of a luminescence response of the temperature indicative agents may be done using any suitable detector sensitive in the wavelength range where the temperature indicative agents are emitting. The temperature sensor further may comprise an electromagnetic radiation source 21, that generates an incident electromagnetic radiation beam L1 which is transmitted into the carrier 11. The means for emitting incident electromagnetic radiation may for instance be an electromagnetic radiation source such as but not limited to a laser or a light emitting diode (LED), optionally provided with some optics for shaping and directing the incident electromagnetic radiation beam. Alternatively, the radiation source may be separate, i.e. not part, of the temperature sensor 10.

The temperature sensor 10 of embodiments of the present invention may comprise both means for emitting incident electromagnetic radiation and means for determining the intensity of electromagnetic radiation reflected from the temperature detection surface.

The described temperature sensor 10 allows a sensitive and precise quantitative or qualitative temperature detection in a temperature detection area of the carrier surface. This is due to the fact an evanescent wave is generated that extends from the carrier surface a short distance into the adjacent material. If electromagnetic radiation of this evanescent wave is scattered or absorbed differently by a temperature indicating agent present at the carrier surface, it will be missing in the reflected electromagnetic radiation beam. The amount of electromagnetic radiation in the reflected electromagnetic radiation beam (more precisely the amount of electromagnetic radiation missing in the reflected electromagnetic radiation beam when compared to the incident electromagnetic radiation beam) is therefore an indication of state in which the temperature indicating agent is at the temperature detection surface. Alternatively a luminescence response can be an indication of state in which the temperature indicating agent is at the temperature detection surface. One advantage of the described optical detection procedure comprises its accuracy as the evanescent waves explore only a small volume of typically 10 to 300 nm thickness above the temperature indicating surface and as the temperature indicating agent can be placed exactly at the area of interest. Moreover, the optical detection can optionally be performed from a distance, i.e. without mechanical contact between the carrier and the electromagnetic radiation source or electromagnetic radiation detector.

By way of illustration, the present invention not being limited thereto, a number of particular embodiments will further be discussed.

In a first particular embodiment, a temperature sensor 10 as described above is provided wherein a number of temperature indicating agents is deposited onto the temperature detection surface 12, spread over the area of interest of the temperature detection surface in order to permit a good control of the temperature, and/or the homogeneity thereof. Providing several areas marked by temperature indicating agents on the surface of the carrier permits to assess the homogeneity of the temperature on this surface. Retrieving this information permits either to take appropriate measures for correcting inhomogeneity of temperature or to take it into account when effecting the analysis. These one or more temperature indicating agents can be deposited on the temperature detection surface as a layer or as spots. The temperature indicating agent may be deposited on the carrier as a layer, leading to a continuous distribution. This deposition can be made by any method known in the art such as, but not limited to, solvent casting from solution, spin coating, spraying, blade coating, painting, dip coating, screen printing and the like eventually followed by curing (e.g. UV or heat curing). If the one or more temperature indicating agents are deposited onto the carrier as spots leading to a discontinuous distribution, the spot deposition method used can be any spotting method known in the art, such as for example ink-jet printing, (micro) contact printing, plotting. Alternatively, photo-lithography can be used (deposition of a layer using the method described above, local polymerization of hydrogel element (UV polymerization through a mask) and subsequent removal of uncured material).

In a second particular embodiment, a temperature sensor 10 as described above is disclosed, wherein different temperature indicating agents having different transition temperatures are deposited at different locations of the same temperature detection surface. An array of temperature indicating agents may be printed on the temperature detection surface, wherein each agent changes an optical property at a specific transition temperature Tc. In this embodiment, a more precise idea of the exact temperature can be assessed rather than merely concluding on the fact that the temperature detection surface or a particular area of this surface is either above or under a certain critical temperature. The deposition of the different temperature indicating agents may be performed by depositing a number of different agents at different spots, or by varying the composition of a layer of temperature indicative agents. The deposition can be performed using a method as described in the previous embodiments.

In a third particular embodiment of the present invention, a temperature sensor 10 as described above is disclosed, wherein two temperature detecting agents with a slightly different transition temperature are printed next to each other. One temperature detecting agents has a transition temperature slightly below the desired temperature and the other one has a transition temperature slightly above this temperature. By analyzing the two elements with a detection means (e.g. a photodetector, a 2D-camera, etc.), the temperature can be accurately controlled between the two extremes given by the transition temperatures of these two different temperature detecting agents. Also the temperature indicating agents can be distributed over the temperature detection surface of the carrier in order to obtain information about the temperature distribution over this surface.

In a second aspect, the present invention relates to a method for obtaining temperature-related information. In an embodiment, the present invention relates to a method for gaining temperature-related information comprising the steps of obtaining a carrier having a temperature detection surface comprising one or more temperature indicating agents operating by changing an optical property and obtaining temperature-related information from the one or more temperature indicating agent. Obtaining the temperature-related information may be performed by directing an incident electromagnetic radiation into the temperature sensor, e.g. into the carrier, such that the temperature indicating agents experience evanescent wave excitation at or near the detection surface, and detecting an optical response of the temperature indicating agents. Such an optical response may for example be a detection of the intensity of electromagnetic radiation reflected from the temperature detection surface, e.g. due to frustrated total internal reflection, or it may be for example a luminescence response detected from the temperature indicating agents after these have been excited using evanescent wave excitation.

During storage of the temperature sensor (e.g. as being a part of a microfluidic biosensor cartridge) before the actual test is carried out, the hydrogel elements can be in their dry state i.e. they do not contain any aqueous fluid. In other words, the method may comprise storing the temperature sensor in a dry way. When the temperature sensor is contacted with a fluid, as it would be the case if the temperature sensor is part of biosensor cartridge and if a sample fluid is filled within the cartridge, the temperature may already be above the T_{c}(LCST) of one or more of the hydrogel elements. In such a case, the swelling would be limited. As a consequence the one or more hydrogel element would not start to scatter the evanescent electromagnetic radiation even if the temperature is above T_{c}. Therefore, in an embodiment of the present invention, the method furthermore comprises hydrating the temperature indicating agents at a temperature below T_{c} prior to the measurement.

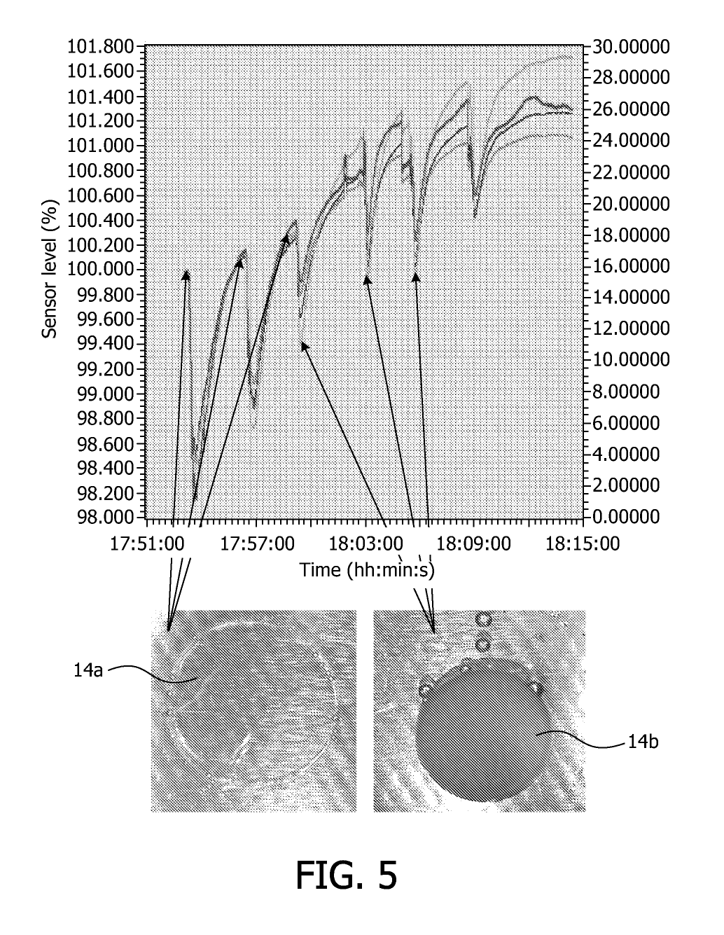

In an alternative embodiment schematized in FIG. 4, the temperature indicating agents 14 present on the temperature detection surface 12 of the carrier 11 are not hydrated before to perform the measurement. In this embodiment, if an assay is performed in an aqueous media (see FIG. 4(A)), the temperature during the assay is assessed after the test by heating up the device above T_{c}(see FIG. 4(B)). If the temperature was below T_{c} during the assay, the hydrogel took up water during the assay, resulting in scattering of the evanescent wave afterwards. When it was above T_{c} no hydration took place and the spot stays transparent. FIG. 4 shows how this procedure would work for an array of spots with different T_{c}.

In an embodiment, the index of refraction n is used as parameter to measure the temperature. A hydrogel with T_{c} below temperature T swell only to a limited extend and n stays close the n_{polymer} ˜1.5. A hydrogel with T_{c} above temperature T will swell and n comes close to n_{water} ˜1.3. A change in n will affect the critical angle of reflection of the incident beam, which can be detected with the photodetector. In this embodiment the plastic sensor surface at the position of the temperature sensors may be corrugated or made rough. In this way the incoming electromagnetic radiation will hit the plastic-hydrogel surface at a range of angles. Outcoupling will change depending on the refractive index of the hydrogel.

In another embodiment, the temperature indicating agents emit radiation in response to the evanescent wave excitation and detection of such emitted radiation is performed. The latter may be performed in any suitable way, e.g. using an optical detector and the requirements on the detector position are less stringent compared to detection of frustrated total internal reflection, in view of the emission pattern of the temperature indicating agents.

The carrier may have additionally several other functions than its temperature sensing function. In an embodiment, an advantageous additional function of the carrier is to serve in the detection of one or more analytes. In this embodiment, this is preferably operated at the level of an analyte detection surface.

Further methods steps may be based on the functionality of the different features and components of the temperature sensor as described in the first aspect.

In a third aspect, the present invention relates to a sensor device, e.g. analytical sensor, for instance a device for detecting one or more analytes in a sample fluid (such as e.g. a biosensor device). Such devices are useful as analytical and diagnostic tools in the fields of human and veterinary medicine, among others. In particular, the present invention relates to a method of analysis of a sample fluid suspected of containing one or more analyte molecules such as small molecules, metabolites, cells, proteins and nucleic acids in complex biological mixtures (e.g. blood, urine, saliva), which method can be used for on-site testing and for molecular diagnostic tests, e.g. for measuring the presence of infectious disease pathogens and resistance genes, for testing food and for performing environmental diagnostics. The biosensor device comprises a temperature sensor according to any of the temperature sensors as described above. In general and unless provided otherwise, in embodiments where the carrier comprises both a temperature detection surface and an analyte detection surface, the temperature detection surface and the analyte detection surface advantageously may be the same surface of the carrier and will be referred to as the “detection surface”. An embodiment of the present invention relates to a temperature indicator based on temperature responsive polymers integrated in the optical detection area of a micro fluidic cartridge. The temperature indicator can be read by the same means as the detection of the biomolecules in the analyte. In another embodiment, the temperature detection and the analyte detection may be operated at distinct areas of the detection surface, i.e. at one or more temperature detection areas and at one or more analyte detection areas.

When the temperature indicating agents are deposited as one or more spots, and when analyte detection agents (e.g. probes or analyte analogs) are present on the detection surface, preferably, the spots are located at places distinct from the location of the analyte detection agents (e.g. probes or analyte analogs). This is advantageous because it avoids the contamination of the analyte detection agents (e.g. probes or analyte analogs) by the temperature indicating agents. It is also advantageous to apply the one or more spots by an ink-jet printing method because it permits the use of a single method to deposit both the temperature indicating agents and the analyte detection agents (e.g. probes or analyte analogs) at the detection surface. However the present invention is not limited to ink jet printing. If a temperature indicating agent is deposited as a layer on the carrier, this layer of temperature indicating agents may be deposited before the application of analyte detection agents (e.g. probes or analyte analogs). The layer of temperature indicating agents may be deposited either before or after the application of the analyte detection agents (e.g. probes or analyte analogs). Application of the temperature indicating agents may advantageously be performed prior to the application of the analyte detection agents, e.g. probes, as such probes may be quite vulnerable and it may be advantageous to reduce the number of processing steps after application of the probes as much as possible. If the one or more temperature indicating agents are deposited onto the carrier as spots leading to a discontinuous distribution, the spotting method used can be any spot depositing method known in the art, and preferably the same method as the method used to spot the analyte detecting agents. The temperature indicating spots may be deposited either before or after the application of the analyte detecting agents. The temperature indicating agent used in a bio sensor according to an embodiment of the present invention may operate by changing an optical property at a temperature within a range between about 0° C. and 95° C. In the case of protein detection, a useful range may be from 35° C. to 40° C. In the case of DNA detection, a useful range may be from 42° C. to 65° C. and another useful range (especially during the washing step) may be from 60° C. to 95° C. The selection of the most appropriate temperature indicating agent may depend upon parameters such as the sample fluid to be analyzed, in particular the analytes contained therein.

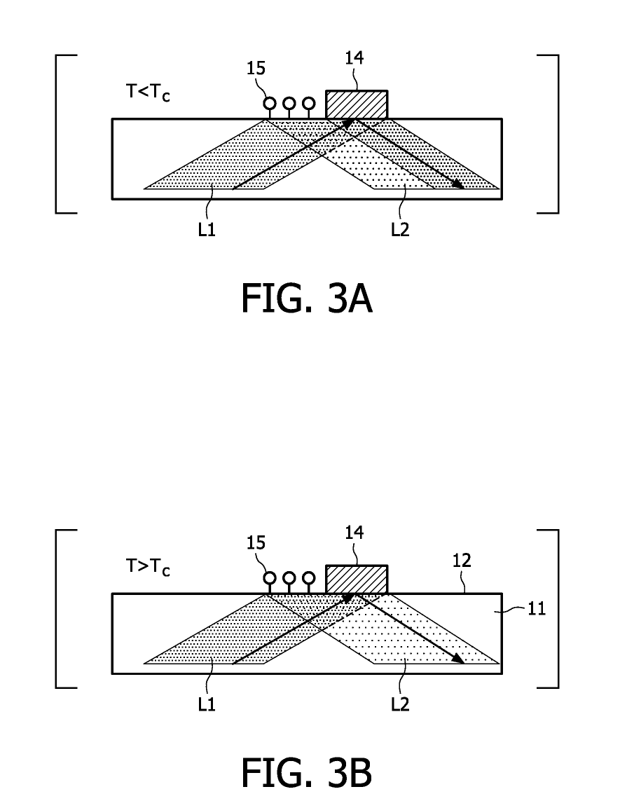

According to one embodiment of the invention, the means for the determination of the presence of the one or more analytes (e.g. target biological compounds) and the means for retrieving temperature-related information from the one or more temperature indicating agents may use the same carrier and optionally use the same optical components, the same irradiation means and the same detection means. The means for determining the presence of the one or more analytes and the means for retrieving temperature-related information may be the same means, except for the probes and the temperature indicating agents, or may comprise common means. Some common means may be optical means such as FTIR optical detection means or an other type of optical detection means. This is advantageous because it provides both an economical and practical construction of the device. The described sensor device may allow a sensitive and precise quantitative or qualitative detection of analytes in a detection area at the detection surface while also providing temperature related information concerning the detection area. This is due to the fact that the incident electromagnetic radiation beam generates an evanescent wave that extends from the carrier surface a short distance into the adjacent material. If electromagnetic radiation of this evanescent wave is scattered or absorbed by analytes or label particles present at the detection surface, it will be missing in the reflected electromagnetic radiation beam. Alternatively analytes or label particles present at the detection surface may generate a luminescence response. Similarly, if electromagnetic radiation of this evanescent wave is scattered or absorbed by temperature indicating agents present at the detection surface, it will be missing in the reflected electromagnetic beam. Alternatively, the temperature indicating agents present at the detection surface may generate a luminescence response. The amount of electromagnetic radiation in the reflected electromagnetic radiation beam (more precisely the amount of electromagnetic radiation missing in the reflected electromagnetic radiation beam when compared to the incident electromagnetic radiation beam) or in the luminescence response is therefore an indication of the presence and the amount of analytes/labels at the detection surface, and or an indication of the temperature at the detection surface. One advantage of the described optical detection procedure comprises its accuracy as the evanescent waves explore only a small volume of typically 10 to 300 nm thickness next to the detection surface, thus avoiding disturbances from the bulk material behind this volume. A high sensitivity is achieved when the reflected electromagnetic radiation is measured as all effects are detected that reduce the amount of detected, e.g. totally internally reflected, electromagnetic radiation. FIG. 2 exemplifies, by way of illustration, a device in action for detecting one or more analytes in a sample fluid according to an embodiment of the present invention using total internal reflection. The exemplary device may be a magnetic biosensor comprising a carrier 11 comprising a detection surface 12, a detection area 13, optical structures 16 and 17, optional means 21 for emitting incident electromagnetic radiation L1, optional means 31 for detecting the intensity of electromagnetic radiation 31, optional optical elements 222 and two optional magnets 19 and 20. Further represented on this figure are label particles 18 in a sample fluid 22. The portion of the detection surface put between brackets is enlarged in FIG. 3. In FIG. 3A, a situation is schematised wherein the temperature of the detection area is lower than Tc. An incident electromagnetic beam L1 is represented hitting the detection surface and being reflected as L2. A portion of L2 is displayed having a reduced intensity due to interaction of the evanescent wave with bounded magnetic labels 15. The temperature indicating agent 14 being below its critical temperature, it remains transparent to the evanescent wave which does not loose in intensity in the corresponding part of the L2. In FIG. 3B, the temperature has been risen above Tc and the temperature indicating agent 14 becomes scattering and changes the refractive index. As a consequence, the corresponding part of the reflected electromagnetic radiation L2 also looses in intensity. Alternatively, for detecting, instead of the reflected electromagnetic radiation L2, also another luminescence response of the labels and/or temperature indicating agents could be measured, if present.

Referring to FIGS. 2 and 3, an exemplary embodiment of a method of analysis of a sample fluid suspected of containing one or more analytes will now be described. For small molecule detection a so-called competitive sandwich assay may used (the invention is not limited to this competitive sandwich assay. The competitive assay is only used for illustration of the principle. Other assays such as agglutination or sandwich assay are equally suited). Free magnetic beads labels 18, specifically functionalized for the analyte to be detected, are dispensed in the fluid 22 (e.g. saliva, blood) to be analysed. When present in the fluid the analyte molecules can bind to the magnetic beads. The magnetic beads are subsequently attracted towards the detection surface 12 with a magnet 19. The detection surface 12 may be already coated with molecules that are identical to the analyte molecules to be detected in the fluid 22. When the analyte molecules are present in the fluid 22 and have reacted with the magnetic beads 18, the beads do not bind to the sensor surface and are pulled away from the surface when attracted with the “washing magnet” 20. When the analyte is not present, the magnetic beads 18 bind to the sensor surface (immobilised magnetic beads 15) resulting in scattering of the evanescent wave of the incoming laser beam L1 and a concomitant decrease of the intensity of the reflected beam L2. The reflected beam L2 is recorded with a photo detector or a CCD camera 31. Alternatively, if the particles provide an optical response to the evanescent wave excitation, such optical response may be recorded with a photo detector or CCD camera 31, which then, depending on the emission pattern, may be positioned outside the total internal reflection angle.

In a particular embodiment of the invention, the device for detecting one or more analytes in a sample fluid comprises a field generator for generating a magnetic and/or an electrical field that can affect the label particles. The field generator may for example be realized by a permanent magnet, a wire, a pair of electrodes, or a coil. The generated field may affect the label particles for instance by inducing a magnetization or a polarization and/or by exerting forces on them. Such a microelectronic sensor device allows a versatile manipulation of analytes via fields, which may for example be used to accelerate the collection of analytes at the detection surface and/or to remove undesired (unbound or, in a stringency test, weakly bound) components from the detection surface.

In another particular embodiment, the device for detecting one or more analytes according to the present invention comprises a sample chamber which is located adjacent to the detection surface and in which a sample suspected to comprise one or more analytes can be provided. The sample chamber is typically an empty cavity or a cavity filled with some substance like a gel that may absorb a sample substance. It may be an open cavity, a closed cavity, or a cavity connected to other cavities by fluid connection channels.

The device for detecting one or more analytes may be used for a qualitative detection of analytes, yielding for example a simple binary response with respect to particular analytes (“present” or “not-present”). Preferably the sensor device comprises however an evaluation module for quantitatively determining the amount of analytes in the detection area from the detected reflected electromagnetic radiation or optical, e.g. luminescence response. This can for example be based on the fact that the amount of electromagnetic radiation in an evanescent electromagnetic radiation wave, that is absorbed or scattered by analytes or the amount of luminescence response, is proportional to the concentration of these analytes in the detection area. The amount of analytes in the detection area may in turn be indicative of the concentration of these components in an adjacent sample fluid according to the kinetics of the related binding processes. This kinetic being temperature dependent, the simultaneous assessment of the temperature, by analyzing the signal providing from the electromagnetic radiation reflected from below the temperature indicating agents, is particularly advantageous here.

In a further development of the aforementioned embodiment, the device for detecting one or more analytes in a sample fluid comprises a recording module for monitoring the determined amount of totally internally reflected electromagnetic radiation or the determined amount of optical, e.g. luminescence, response upon evanescent wave excitation over an observation period. Thus it will be possible to monitor the kinetics with which analytes collect at or depart from the detection surface. This may reveal valuable information about the analytes and/or the temperature. The evaluation module and/or the recording module are typically coupled to the electromagnetic radiation detector and may be realized by some data processing hardware, e.g. a microcomputer, together with associated software. Such an evaluation module and/or recording module is equally valuable in a temperature sensor according to other embodiments of the present invention.

In the following, several embodiments of the device for detecting one or more analytes in a sample fluid will be considered in which the detection surface comprises a plurality of detection areas at which different incident electromagnetic radiation beams can be totally internally reflected. One carrier then allows the processing of several detection areas and thus for example the search for different analytes, the observation of the same analytes under different conditions (e.g. different temperatures) and/or the sampling of several measurements for statistical purposes. The “different incident electromagnetic radiation beams” may optionally be components of one broad electromagnetic radiation beam that is homogeneously generated by the electromagnetic radiation source. Such plurality of detection areas is equally valuable in a temperature sensor according to other embodiments of the present invention.

The different incident electromagnetic radiation beams that are used in the aforementioned embodiment may be different with respect to time. This is for example the case if the device for detecting one or more analytes in a sample fluid comprises a scanning module for sequentially coupling the electromagnetic radiation source to different detection areas. Alternatively or additionally, it may comprise a scanning module for optically coupling the electromagnetic radiation detector to different detection areas on the detection surface. The scanning modules may for example comprise optical components like lenses or mirrors for directing the incident or the reflected electromagnetic radiation beam in a suitable way. The scanning modules may also comprise means for moving the carrier with respect to the electromagnetic radiation source and/or electromagnetic radiation detector. Such a scanning module is equally valuable in a temperature sensor according to other embodiments of the present invention.

In another embodiment of the device for detecting one or more analytes in a sample fluid with a plurality of detection areas, a plurality of electromagnetic radiation sources and/or a plurality of electromagnetic radiation detectors is present that are directed to different detection areas at the detection surface. In this case it is possible to process a plurality of detection areas simultaneously, thus speeding-up the associated measurement process accordingly. This embodiment can of course be combined with the previous one, i.e. there may for example be a scanning module for scanning the incident electromagnetic radiation beams of a plurality of electromagnetic radiation sources over different arrays of detection areas and/or a scanning module for directing the reflected electromagnetic radiation beams or optical, e.g. luminescence, responses from different arrays of detection areas to a plurality of electromagnetic radiation detectors. By using scanning modules, the number of electromagnetic radiation sources/detectors can be kept smaller than the number of detection areas. This embodiment applies mutatis mutandis in a temperature sensor according to other embodiments of the present invention

In another embodiment with a plurality of detection areas, the microelectronic sensor device comprises a plurality of individually controllable (magnetic or electrical) field generators that are associated to different detection areas. In this case it is possible to manipulate the label particles in each detection area individually according to the requirements of the particular tests that shall be performed there.

In embodiments of the present invention, the device for detecting one or more analytes in a sample fluid may in principle be used with any kind of label particles. It is however advantageously provided or used with label particles that specifically fit to the other components of the device. In a particular embodiment of the present invention, the device for detecting one or more analytes in a sample fluid may for instance comprise label particles with a mantle of a transparent material, wherein this mantle typically covers (completely or partially) one or more kernels of another material, e.g. iron-oxide grains. In this case electromagnetic radiation of an evanescent electromagnetic radiation wave at the detection surface can readily enter the label particles where it is absorbed and/or scattered and thus lost for the reflected electromagnetic radiation beam and/or generates a luminescence response. The transparent material of the mantle may particularly be a material with a similar refractive index as the material of the carrier, because this optimizes the transition of electromagnetic radiation from the carrier to the label particles. The mantle may for example consist of the same material as the carrier. When magnetic beads are used in embodiments of the present invention, they may for instance be poly-styrene spheres filled with small magnetic grains (e.g. of iron-oxide). This causes the beads to be super-paramagnetic. The refractive index of poly-styrene is nicely matched to the refractive index of a typical substrate material of well-plates. In this way optical outcoupling of electromagnetic radiation is enhanced.

As an optional feature, the device for detecting one or more analytes according to the present invention may comprise an (further) electromagnetic radiation detector for determining (qualitatively or quantitatively) fluorescence electromagnetic radiation emitted by analytes at the detection surface. The fluorescence can be stimulated by the evanescent wave of the incident electromagnetic radiation beam in a small volume adjacent to the detection surface and then be detected, thus indicating the presence (and amount) of fluorescent analytes. As described above, this also may be an alternative to the detection of reflected electromagnetic radiation.

As another optional feature, the device for detecting one or more analytes in a sample fluid may further comprise a heat control means for rising the temperature of the sample fluid and/or the detection area. This feature is advantageous because external heating means are no longer required. It is an advantage that the heat control means may comprise a heating means. The heat control means may be adapted for controlling a temperature of the detection surface based on or as function of the obtained temperature-related information. The heat control means may comprise, for example as another optional feature, cooling means for lowering the temperature of the sample fluid and/or the detection area. This feature is advantageous because external cooling means are no longer required. Both heating and/or cooling means may be provided, e.g. a resistive heater or a Peltier element.

When the device for detecting one or more analytes in a sample fluid further comprises heating means, the device for detecting one or more analytes in a sample fluid may further comprise as another optional feature in addition to the means for gaining temperature related information, a processing means for adjusting the power output of the heating means (e.g. in response to the gained temperature related information) in order to reach and maintain a predefined temperature. When the device for detecting one or more analytes in a sample fluid further comprises a cooling means, the device for detecting one or more analytes in a sample fluid may further comprise as another optional feature in addition to the means for gaining temperature related information, processing means for adjusting the operation of the cooling means (e.g. in response to the gained temperature related information) in order to reach and maintain a predefined temperature.

In a fourth aspect, the present invention relates to a cartridge (e.g. a cell) for providing a sample to be investigated, wherein the cartridge comprises a temperature sensor as described above. The cartridge may be particularly suitable as disposable cartridge that can be read in a cartridge reader. The cartridge may be particularly suitable as a cartridge for a microelectronic sensor device as described in the third aspect. The cartridge comprises furthermore a sample chamber in which a sample can be provided. The sample chamber has a transparent inspection wall comprising the features of the carrier as described for the first aspect. The inspection wall therefore comprises temperature indicating agents and is adapted as to be able to provide an optical response of the temperature indicating agents using evanescent wave excitation, e.g. using frustrated total internal reflection, having the same features and advantages as described in the first aspect of the present invention. Furthermore the carrier surface may be adapted for coupling target particles of interest, as described and illustrated in the third aspect.

The inspection wall may have the basic form of a plate with a substantially parallel interior and exterior surface, wherein the interior surface comprises the detection surface and wherein the optical structure projects outwards from the exterior surface. Alternatively the optical structure may also project inwards from the exterior surface. Moreover, the inspection wall can in principle be any part of the wall of the sample chamber, for example a side wall or the top. Preferably, the inspection wall is however a part of the bottom of the carrier (or the whole bottom), which has two advantages: First, sample components underlying sedimentation will concentrate at the detection surface of the bottom. Second, the components of an associated instrument can be disposed below the bottom, thus leaving space at the sides of the carrier for a possible arrangement of further carriers. The described cartridge has the advantage that a sample inside its sample chamber can optically be investigated with an incident electromagnetic radiation beam that is totally internally reflected, thus providing an evanescent field in a small volume at the detection surface. Effects like absorption or scattering taking place in this small volume will affect the reflected electromagnetic radiation beam which leaves the carrier. Additionally or alternatively, fluorescence may be stimulated by the evanescent wave in fluorescent analytes and thus provide an indicator for the target. As both the incident electromagnetic radiation beam and the reflected electromagnetic radiation beam or luminescence electromagnetic radiation beam are directed from the outside towards the carrier or vice versa, the corresponding electromagnetic radiation source and electromagnetic radiation detector can be arranged a distance away and separate from the carrier.

The detection area of the carrier may optionally be covered with at least one type of capture element that can bind one or more analytes. A typical example of such a capture element is an antibody to which corresponding antigens can specifically bind. By providing the detection area with capture elements that are specific to certain analytes, it is possible to selectively enrich these analytes in the detection area. Moreover, undesired analytes can be removed from the detection surface by suitable (e.g. magnetic) repelling forces (that do not break the bindings between desired analytes and capture elements). The detection surface may preferably be provided with several types of capture elements that are specific for different analytes. In a device for detecting one or more analytes in a sample fluid with a plurality of detection areas, there are preferably at least two detection areas having different capture elements such that these regions are specific for different analytes. Optionally, each detection areas can be individually controlled in temperature by means of heating devices and/or cooling device with or without a feed-back loop responding to temperature-related information gained from means for gaining such information

The carrier may further optionally comprise a cavity in which a (magnetic or electrical) field generator can at least partially be disposed. The source of the field can thus be positioned as close as possible to the detection surface, allowing to generate high field strengths in the detection area with minimal effort (e.g. electrical currents) and with minimal disturbances for other regions (e.g. neighbouring detection areas). Moreover, such a cavity can be used to center the carrier with respect to the field generator, the electromagnetic radiation source and the electromagnetic radiation detector.

While in some embodiments, the device for detecting one or more analytes in a sample fluid may in principle be constructed as a “one-piece” unit of solidly mounted components, it is preferred that the carrier is designed as an exchangeable component of the device, for example a well-plate. Thus it may be used as a low-cost disposable part, which is particularly useful if it comes into contact with biological samples and/or if its coating (e.g. with antibodies) is used up during one measurement process.

The invention further relates to a well-plate which comprises a plurality of cartridges of the kind described above, i.e. a plurality of sample chambers with transparent inspection walls having on their interior side a detection surface and on their exterior side at least one optical structure, wherein the optical structure allows an incident electromagnetic radiation beam coming from outside the carrier to enter the inspection wall, to be totally internally reflected at the detection surface, and then to leave the inspection wall as a reflected electromagnetic radiation beam that is directed away from the carrier. Alternatively, the incident electromagnetic radiation beam, being an evanescent wave excitation beam, may generate a luminescence response that is directed away from the carrier. The well-plate may combine a plurality of the carriers described above in an array and thus allows a parallel investigation of a multitude of samples and/or of one sample in a multitude of investigation assays. As the well-plate is based on the described carrier, reference is made to the above description for more details on the advantages, features and improvements of the well-plate. Such a well plate can advantageously be used in an environment of a laboratory, as it comprises an array of many sample chambers (“wells”) thus allowing that different tests can take place in parallel.

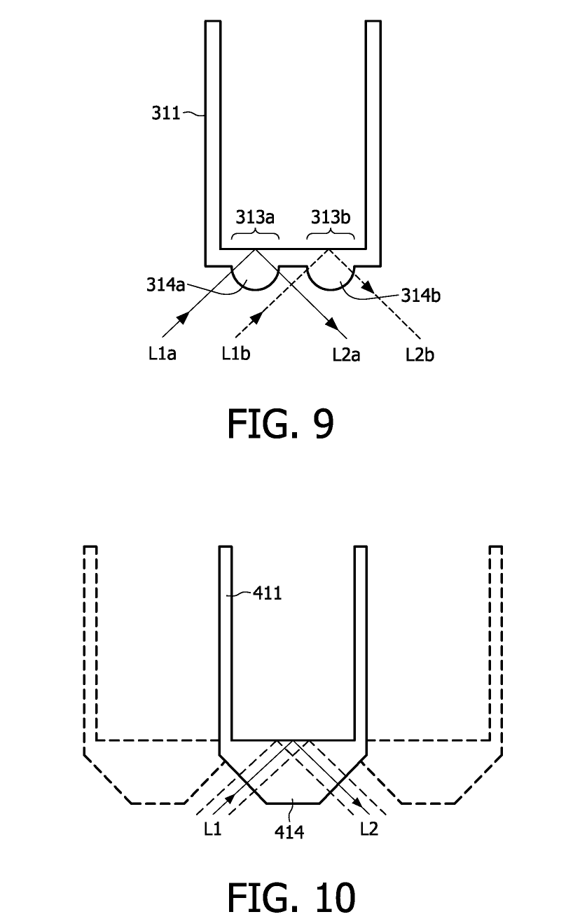

In the following, by way of illustration, some features of various embodiments of the invention will be described that can be applied to a microelectronic sensor device, a carrier and a well-plate of the kind described above. FIGS. 7 to 11 show different possible embodiments of one cartridge or one well of a well-plate that can be used for an application using evanescent wave excitation, e.g. frustrated total internal reflection. The production of the cartridge or of these (disposable) wells is very simple and cheap as a single injection-moulding step is sufficient.

In FIG. 7, the irradiation for an exemplary cartridge or well is described in more detail. The electromagnetic radiation source 121 shown in FIG. 7 is arranged to produce a parallel electromagnetic radiation beam L1, incident at the well bottom surface at an angle larger than the critical angle θ_{c}. To prevent excess reflection of this incident electromagnetic radiation beam L1 at the first interface from air to the carrier 111 (e.g. glass or plastic material), the bottom of the well comprises a hemispherical shape 114 of radius R, with its centre coinciding with the detection surface 112. The incident electromagnetic radiation beam L1 is directed towards this same centre. At the reflection side, a photodetector such as a photodiode 131 is positioned to detect the intensity of the reflected electromagnetic radiation beam L2. A typical diameter D of the well 102 ranges from 1 to 8 mm. The FIG. 7 further indicates a magnet 141 for generating magnetic actuation fields inside the well 102.

FIG. 8 shows an alternative embodiment in which the electromagnetic radiation source comprises some optical element like a lens 222 to produce an incident electromagnetic radiation beam L1 which is substantially focused to the centre of the hemisphere 214. At the detection side, a similar optical element 232 can be used to collect and detect the electromagnetic radiation intensity of the reflected electromagnetic radiation beam L2.

In a further development of the measuring procedure, multiple incident electromagnetic radiation beams and reflected electromagnetic radiation beams can be used to simultaneously detect the presence of different target molecules at different locations and eventually temperature in the same well. FIG. 9 shows in this respect a well with multiple hemispheres 314a, 314b on the well bottom that can be used to couple the electromagnetic radiation from multiple incident electromagnetic radiation beams L1a, L1b to respective detection areas 313a, 313b on the bottom of the well. Multiple photodetectors (not shown) may be used in this case to measure the multiple reflected electromagnetic radiation beams L2a, L2b.

FIG. 10 shows an alternative embodiment in which a prism or truncated pyramidal structure 414 is used to couple the electromagnetic radiation of the incident electromagnetic radiation beam L1 and the reflected electromagnetic radiation beam L2. The sloped edges of the pyramid should be substantially perpendicular to these electromagnetic radiation rays. Advantages of this design are that it is simple to produce and does not block beams from neighboring areas. Neighboring wells are indicated in this Figure by dashed lines.

As indicated in FIG. 10, it is possible to use a single, parallel incident electromagnetic radiation beam L1 with a diameter covering all detection areas on the well bottom. As a detector, multiple photodiodes can be used, aligned with each individual detection area. Alternatively, a CCD or CMOS chip (not shown) such as used in a digital camera can be used to image the reflected intensity response of the entire well bottom, including all detection areas. Using appropriate signal processing, all signals can be derived as with the separate detectors, but without the need for prior alignment.

FIG. 11 shows a further embodiment in which the well bottom 511 comprises an open cavity 515 with its center outside the optical path of the incident electromagnetic radiation beam(s) L1 and the reflected electromagnetic radiation beam(s) L2. This allows that a magnetic core 542, e.g. T-shaped ferrite core, of a magnetic coil 541 can be placed close to the detection surface 512 for improved field intensity and concentration, allowing a compact and low-power design. Furthermore, a self-aligning structure can be achieved which can be seen as follows: if the optics and the magnetic field generator 541 are fixed, an auto-alignment of the well on the ferrite core 542 takes place.

In another aspect, the present invention relates to a method of producing a temperature sensor. The method comprises providing a carrier having a detection surface wherein the temperature sensor is adapted for, e.g. by its design, receiving an incident electromagnetic radiation beam directed from outside the carrier can enter the carrier and induce evanescent wave excitation at a detection surface. The carrier may furthermore be adapted so that the electromagnetic radiation beam directed from outside the carrier can enter the carrier and experience frustrated total internal reflection. The method also comprises applying at the detection surface, one or more temperature indicating agents whereby an optical property of the temperature indicating agents changes depending upon temperature.

In still a further aspect, the present invention relates to a method of analysis of a sample fluid suspected of containing one or more analyte molecules such as target biological compounds. The method thereby comprises detecting an optical response using from one or more temperature indicating agents each operating by changing an optical property with temperature, so as to gain temperature-related information from the one or more temperature indicating agents, whereby the temperature indicating agents are excited using evanescent wave excitation. Detection may be based on FTIR. Obtaining temperature-related information may be performed before contacting the sample with the detection surface, i.e. to adjust the temperature, or it may be used as a control step to control whether the temperature used was according to a predetermined criterion. The method further comprises contacting the sample fluid with the optical detection area, and analyzing the sensor substrate after contacting the sample fluid so as to determine the presence and/or the concentration of the one or more analyte molecules, e.g. target biological compounds. The latter advantageously may be done using FTIR. The obtained temperature-related information may be taken into account for extrapolating the measured concentration, measured using evanescent wave excitation and FTIR detection or detection of a luminescence response, to another temperature, or to identify at which temperature the measurement was performed. Alternatively, the temperature-related information may be used for adjusting, based thereon, the temperature of the sensor substrate where the interaction of the sample is or is to be performed. Thus, as an other optional feature, the analytical method of the invention may further include a pre-heating step of the optical detection area, in order to raise its temperature up to a desirable temperature, e.g. a temperature within the range from about 20 to about 95° C., this pre-heating step preferably occurring prior to the analysis. This feature is advantageous because it permits to perform the method of analysis at the temperature providing the higher binding specificity between the probes and the target biological compounds.

### Example 1

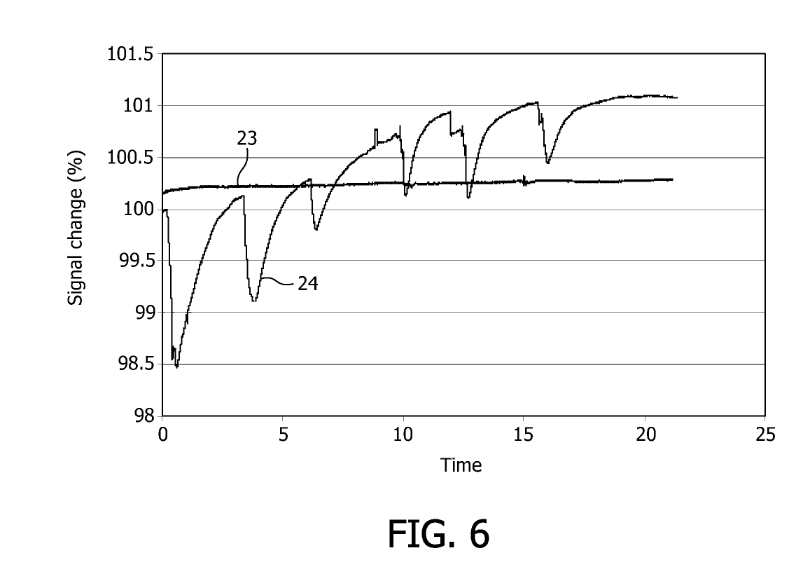

A droplet of a reactive hydrogel monomer mixture was applied on the optical window on top of a carrier (e.g. an optical substrate), suitable for FTIR measurements. The reaction mixture consisted of 25 wt % deionized water, 25 wt % methanol, 48.9 wt % NIPAAm+0.1 wt % diethyleneglycoldiacrylate+1 wt % IRG 2959 photo-initiator. Subsequently, the hydrogel was polymerized by applying UV radiation (100 mW/cm²) for about 90 seconds. The carrier was then placed in an evanescent wave excitation optical reader set-up with a CCD camera and a droplet of cold water was applied on top of the hydrogel. In the present example FTIR detection was used. After a while, hot water (T>50° C.) was applied on top of the hydrogel. The hydrogel turned opaque (see hydrogel 14b in FIG. 5) and the signal measured with the optical reader dropped. After reaching a minimum signal the signal increased again indicating that the gel became transparent (see hydrogel 14a in FIG. 5) due to a decrease of temperature. This was repeated for 6 times. The sensor level during these repetitive steps is shown in FIG. 5. The increasing shift in the baseline is attributed to the fact that the hydrogel was not in equilibrium at the moment the experiment was started and therefore had a decreasing refractive index due to the uptake of water.

### Example 2

### Comparative

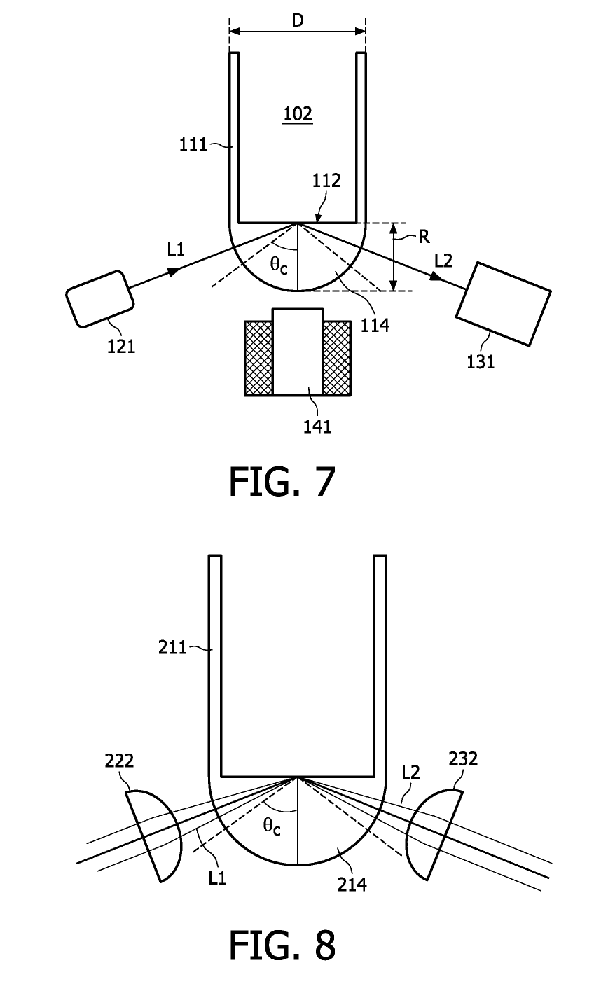

To check whether the decrease of signal is influenced by the temperature of the water or really can be attributed to the gel, the experiment of example 1 was repeated, but this time without the gel and just adding hot and cold water to the optical substrate. The outcome of this experiment is presented in FIG. 6. It is clear from this figure that the cartridge is very stable as function of temperature and that the signal change in example 1 can be really attributed to the hydrogel.

While the invention was described above with reference to particular embodiments, various modifications and extensions are possible. For example, in addition to molecular assays, also larger moieties can be detected with devices for detecting one or more analytes in a sample fluid according to embodiments of the present invention, e.g. cells, viruses, or fractions of cells or viruses, tissue extract, etc. The detection can occur with or without scanning of the sensor element with respect to the sensor surface. Measurement data can be derived as an end-point measurement, as well as by recording signals kinetically or intermittently. The particles serving as labels can be detected directly by the sensing method. As well, the particles can be further processed prior to detection. An example of further processing is that materials are added or that the (bio)chemical or physical properties of the label are modified to facilitate detection. The device and method for detecting one or more analytes in a sample fluid can be used with several biochemical assay types, e.g. binding/unbinding assay, sandwich assay, competition assay, displacement assay, enzymatic assay, etc. It is especially suitable for DNA detection because large scale multiplexing is easily possible and different oligos can be spotted via ink-jet printing on the detection surface. The device and method for detecting one or more analytes are suited for sensor multiplexing (i.e. the parallel use of different sensors and sensor surfaces), label multiplexing (i.e. the parallel use of different types of labels) and chamber multiplexing (i.e. the parallel use of different reaction chambers). The device and method for detecting one or more analytes can be used as rapid, robust, and easy to use point-of-care biosensors for small sample volumes. The reaction chamber can be a disposable item to be used with a compact reader, containing the one or more field generating means and one or more detection means. Also, the device, methods and systems for detecting one or more analytes of embodiments of the present invention can be used in automated high-throughput testing. In this case, the reaction chamber is e.g. a well-plate or cuvette, fitting into an automated instrument.

1. A temperature sensor (10) for obtaining temperature-related information, the temperature sensor (10) comprising a carrier (11) with a temperature detection surface (12), the temperature detection surface (12) is adapted for receiving one or more temperature indicating agents (14) thereon, wherein said one or more temperature indicating agents (14) are operating by changing an optical property at a predetermined temperature and said temperature sensor (10) is adapted for inducing an optical response from said one or more temperature indicating agents (14) using evanescent wave excitation.

2. A temperature sensor (10) according to claim 1, wherein said temperature sensor is adapted for obtaining an optical response from said one or more temperature indicating agents (14) using frustrated total internal reflection.

3. A temperature sensor (10) according to claim 1, wherein said carrier (11) is adapted for receiving an incident electromagnetic radiation beam from outside said carrier (11) such that evanescent wave excitation is experienced at said temperature detection surface (12), and wherein said temperature sensor (10) comprises an optical structure (16) for receiving said electromagnetic radiation beam under an angle appropriate for having evanescent wave excitation at the temperature detection surface and/or an optical structure (17) for appropriately coupling out a frustrated total internal reflected electromagnetic radiation beam.

4. A temperature sensor (10) according to claim 3, wherein said optical structure(s) (16, 17) comprises a surface which is adapted to be perpendicular to said incident electromagnetic radiation beam at the location where said incident electromagnetic radiation is coupled in or said reflected electromagnetic radiation beam at the location where the electromagnetic radiation is coupled out.

5. A temperature sensor (10) according to claim 3, wherein said optical structure(s) (16, 17) is integrated in said carrier (11).

6. A temperature sensor (10) according to claim 3, wherein said optical structure(s) (16, 17) comprises one or more optical elements (222) adapted to focus an incident electromagnetic radiation beam L1 on said temperature detection surface (12).

7. A temperature sensor (10) according to claim 1, wherein at least one of said one or more temperature indicating agents (14) is a temperature responsive polymer, co-polymer or hydrogel.

8. A biosensing device (8) for sensing the presence and/or concentration of one or more analytes in a sample fluid, the biosensing device (8) comprising
a temperature sensor (10) according to claim 1 for obtaining temperature-related information, and
an analyte detection means for detecting said one or more analytes.

9. A temperature indicating agent (14), said temperature indicating agent (14) comprising temperature sensitive structures having at least one temperature dependent dimension such that temperature related information can be derived from the distance between said temperature indicating agent and said surface when said temperature indicating agent is at or near said surface.

10. A temperature indicating agent (15) according to claim 9, wherein the temperature indicating agent (15) is adapted to specifically bind to a surface.

11. A method for gaining temperature-related information comprising the steps of:
a) obtaining a temperature sensor (10) having a temperature detection surface (12) comprising one or more temperature indicating agents (14), each operating by changing an optical property at a predetermined temperature, and
b) obtaining temperature-related information from said one or more temperature indicating agent, by:
directing an incident electromagnetic radiation into said temperature sensor such that it experiences evanescent wave excitation or frustrated total internal reflection at said temperature detection surface (12), and
determining an optical response of said temperature indicating agents (14).

12. A method for analyzing one or more analytes (18) in a sample fluid, the method comprising the steps of:
a) obtaining a temperature sensor (11) comprising a carrier (11) having a temperature detection surface (12) comprising one or more temperature indicating agents (14), each operating by changing an optical property at a predetermined temperature, and a particle detection surface (12),
b) contacting said detection surfaces (12) of said carrier (11) with said sample fluid,
c) obtaining temperature-related information from said one or more temperature indicating agent (14), by:
directing an incident electromagnetic radiation into said temperature sensor (10) such that it experiences evanescent wave excitation or frustrated total internal reflection at said temperature detection surface (12), and
determining an optical response of said temperature indicating agents (14),
d) detecting said one or more analytes (18) in said sample fluid.

13. A method for analysing according to claim 12, wherein said one or more analytes (18) in the sample fluid is performed by directing an incident electromagnetic radiation into said temperature sensor (10) such that it experience total internal reflection or frustrated total internal reflection at said particle detection surface (12) and detecting the intensity of electromagnetic radiation reflected from said particle detection surface (12).

14. A method for analyzing according to claim 12, wherein the method furthermore determining the presence and/or the concentration of said one or more analytes in said sample fluid by combining a detection result for said detecting of said one or more analytes in the sample fluid with the obtained temperature-related information.

15. A method for analyzing according to claim 1, wherein prior to said detecting one or more analytes (18) in the sample fluid, the method further comprises bringing said particle detection surface (12) to a predetermined temperature taking into account said obtained temperature-related information.
